(19) United States
(12) Patent Application Publication
(10) Pub. No.: US 2014/0152770 A1
(43) Pub. Date: Jun. 5, 2014

(54) System and Method for Wide Area Motion Imagery

(71) Applicants: Peter Alexander Carides, San Diego, CA (US); Barry R. Robbins, Carlsbad, CA (US); Dilraj Singh, San Diego, CA (US); Simon H. Dickhoven, Santee, CA (US)

(72) Inventors: Peter Alexander Carides, San Diego, CA (US); Barry R. Robbins, Carlsbad, CA (US); Dilraj Singh, San Diego, CA (US); Simon H. Dickhoven, Santee, CA (US)

(21) Appl. No.: 13/909,997

(22) Filed: Jun. 4, 2013

Related U.S. Application Data
(60) Provisional application No. 61/721,268, filed on Nov. 1, 2012.

(51) Int. Cl. H04N 7/18; H04N 13/02

(52) U.S. Cl. CPC H04N 7/185; H04N 13/02
USPC 348/46

(57) ABSTRACT

A system for detecting moving objects within a predetermined geographical area is provided. The system is designed to convey object movement information from an airborne surveillance platform to a ground-based operator station with reduced data transmission. This is accomplished by computer processing image data on the surveillance platform prior to transmitting data to the ground station. First, the system constructs a 3D model of the area under surveillance, for example, by obtaining many different views of the area using an aircraft. One 3D model is maintained at the surveillance platform, and another is transmitted to the ground station. During a surveillance mission, a succession of relatively low data, 2D images are created and aligned with the surveillance platform's 3D model. The alignment reveals differences in the images (tracking data) which is then transmitted to the ground station for use with the ground station's 3D model to resolve object movement information.

This application claims the benefit of U.S. Provisional Patent Application Ser. No. 61/721,268, entitled SYSTEM AND METHOD FOR WIDE AREA MOTION IMAGERY, filed Nov. 1, 2012. The entire contents of Application Ser. No. 61/721,268 are hereby incorporated by reference herein.

### FIELD OF THE INVENTION

The present invention pertains generally to airborne surveillance and tracking systems. More particularly, the present invention pertains to systems and methods for transmitting surveillance and tracking data from an airborne platform to a ground-based operator station. The present invention is particularly, but not exclusively, useful for effectively and efficiently transmitting image information over a beyond-line-of-sight (BLOS) communication channel having at least one relatively low bandwidth link.

### BACKGROUND OF THE INVENTION

During surveillance missions, the goal is typically to spot interesting activity on the ground. These missions generally generate large amounts of raw two-dimensional (2D) imagery data, often at an airborne surveillance platform, such as an aircraft. Typically, this activity has, for the most part, been restricted to very small portions of the field of view covered by the imaging sensors.

In the past, the images have been transmitted, as raw data, to a ground-based operator station where the data is then processed to obtain useful information. Generally, real-time or near real-time transfer is sought to give the ground-based operator the most up-to-date information concerning the mission. It happens that the real-time transmission of this large amount of raw data from the aircraft to a ground station requires a large bandwidth link.

In some cases, a large bandwidth transmission link is not readily available. For example, in some surveillance missions, the aircraft may be positioned at a location that is beyond-line-of-sight (BLOS) from the ground station. Oftentimes, this requires the data to be relayed, via a satellite or some other airborne vehicle, to the ground-based operator station. Satellite capacity, i.e. bandwidth, for relaying such signals, is often either limited or extremely expensive. For these reasons, real-time transmission of raw image data during BLOS surveillance missions is often infeasible.

Compounding the above-mentioned concerns, each new generation of surveillance equipment typically includes a larger number of sensors than the previous generation, with each new sensor having a higher sensor resolution than its predecessor. This, of course, leads to an ever-increasing amount of raw data being generated, at higher data rates. The higher data rate, in turn, dictates a corresponding increase in bandwidth to support a real-time transfer of raw data from the surveillance platform to the ground-based operator station.

In light of the above, it is an object of the present invention to provide a data reduction approach which gives sufficient intelligence to a ground-based operator during a surveillance mission without necessarily transferring the entire raw imagery data for every image frame to the ground station. Still another object of the present invention is to transmit sufficient surveillance information from an airborne platform to a ground station over a limited bandwidth link to drive actionable intelligence at the ground-based operator station. Still another object of the present invention is to reduce transmission capacity requirements for surveillance missions by migrating processing and storage capabilities into the surveillance platform (e.g. airborne vehicle) that have heretofore typically been done on the ground. Yet another object of the present invention is to provide a system for wide area motion imagery and corresponding methods of use which are easy to use, relatively simple to implement, and comparatively cost effective.

### SUMMARY OF THE INVENTION

In accordance with the present invention, a system is provided for detecting moving objects within a predetermined geographical area. In particular, the system of the present invention is designed to reduce the amount of data that is required in a transmission to convey the information of object movement from an airborne surveillance platform to a ground-based operator station. With the present invention, this is done by effectively increasing computer power requirements on the surveillance platform.

In overview, the methodology of the system for the present invention is functionally threefold. As will be appreciated from the disclosure below, these different functions are interactive.

Initially, the system constructs a three-dimensional model of the geographical area that has been identified for surveillance. Typically, this is done by having an aircraft circle over (i.e. orbit) the area to obtain many different views of the area from many different perspectives. These views are then collectively collated at the surveillance platform to construct a three-dimensional model of the geographical area. One three-dimensional model is maintained at the surveillance platform, and another is transmitted to the ground-based operator station. Thereafter, the three-dimensional model can be periodically updated at both locations, as required.

During a surveillance mission, whenever an interesting activity occurs in the predetermined geographical area, a relatively low data image of the activity is created. Specifically, this image will be two-dimensional, and it will be made with the lowest effective optical resolution. Further, the image will result from an on-demand event, and it can be selectively created from different zoom levels. For the purposes of tracking a moving object in the geographical area, a succession of these two-dimensional images will be created.

Operationally, each two-dimensional image is aligned with the three-dimensional model at the surveillance platform in a process generally referred to as geo-registration. In particular, this geo-registration (alignment) is done to minimize the adverse effects that might otherwise occur with excessive platform motion and/or scene/view angle changes between successive images.

In the event, a combination of the techniques noted above can be effectively employed to greatly reduce data requirements. In particular, with accurate geo-registration alignments, the comparison of successive images are better able to more clearly reveal differences in the images that are indicative of object activity (i.e. movements in the geographical area). The consequence here is that the system's ability to develop tracking data is based solely on the detected differences between successive images. As envisioned for the present invention, it is only this tracking data that needs to be transmitted to a ground-based operator station. There, the tracking data can be evaluated using the previously provided three-dimensional model to detect object movements.

Structurally, the system for detecting a moving object in a predetermined geographical area uses a surveillance platform (e.g. an aircraft) to fly over the area that is targeted for surveillance. Onboard the platform is a computer/comparator, a sensor (e.g. a camera) or a plurality of sensors, and a transmitter. Initially, the sensor is used to collect views of the geographical area (comprising geographical data) that will be collectively collated to construct a three-dimensional model of the predetermined area on the computer.

One copy of the three-dimensional model is maintained on the airborne surveillance platform. Another copy is transmitted to a ground-based operator station.

When an activity of interest is suspected, the sensor (camera) that is mounted on the surveillance platform is then used to create a sequence of two-dimensional images of the suspect region where the activity of interest is occurring. Each image is then geo-registered with the three-dimensional reference model at the surveillance platform. The comparator is then used to collect track data that is based on differences between successive images. For purposes of the present invention, this track data is indicative of a movement of an object in the predetermined area. The transmitter that is mounted on the surveillance platform then transmits the track data to the operator station, where it is geo-registered with the reference model at the operator station to detect the moving object.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a schematic presentation of the operating elements of a system in accordance with the present invention;

FIG. 2 is a representation of a three-dimensional reference model as used by the system of the present invention; and

FIG. 3 shows representative two-dimensional images acquired for use in the method of the present invention.

### DESCRIPTION OF THE PREFERRED EMBODIMENTS

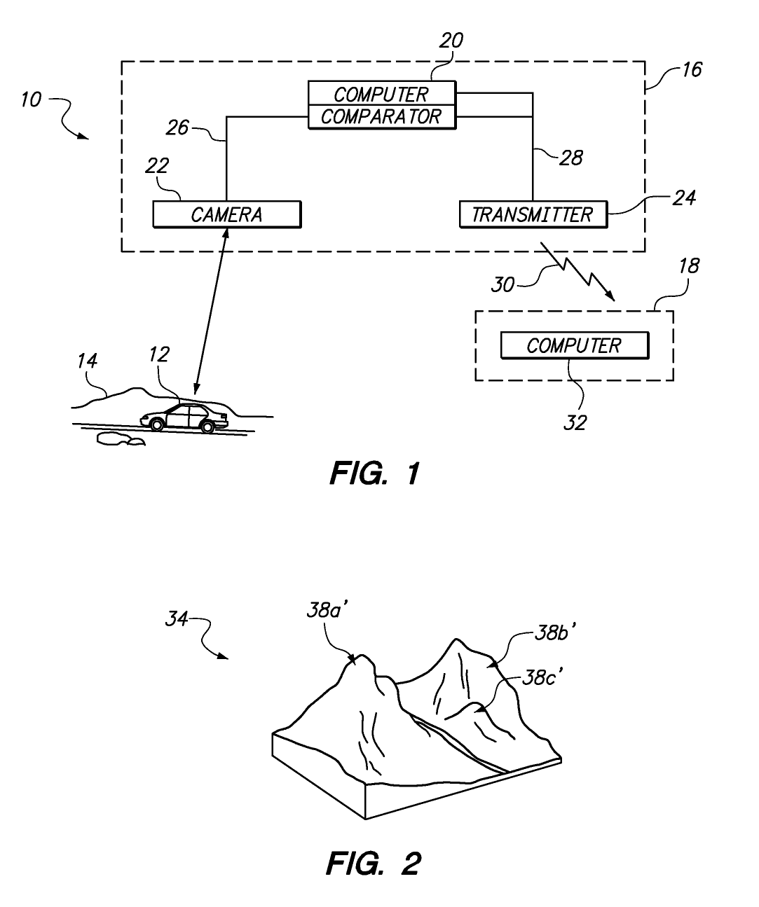

With initial reference to FIG. 1, a system for wide area motion imagery is shown and generally designated 10. As shown, the system 10 can function to detect and/or track a moving object 12, such as a vehicle on the ground 14. FIG. 1 further shows that the system 10 includes an airborne surveillance platform 16 for creating surveillance image(s), processing imagery data and transmitting data to a ground-based operator station 18.

In more structural detail, FIG. 1 shows that constituents of the system 10 on the surveillance platform 16 include a computer/comparator 20, one or more sensors 22, such as one or more cameras, and a transmitter 24. During a surveillance mission, the surveillance platform 16, which is typically an aircraft, is flown over a preselected area. Once over the preselected area, the sensor 22 is used to collect raw imagery data that is transmitted to the computer/comparator 20 via electrical connection 26. The raw data is then processed by the computer/comparator 20 and a low data output is created and sent to transmitter 24 via electrical connection 28. The transmitter 24 then transmits the low data output to the ground-based operator station 18 via link 30.

For use with the system 10, the link 30 can be a relatively low bandwidth link. For example, the surveillance platform 16 may be positioned at a location that is beyond-line-of-sight (BLOS) from the operator station 18. For this case, the data may be relayed, via a satellite (not shown) or some other airborne vehicle, to the ground-based operator station 18. As discussed above, the satellite capacity, i.e. bandwidth, for relaying such signals, is often either limited or extremely expensive.

Once the low data output reaches the ground-based operator station 18, a computer 32 at the ground-based operator station 18 processes the low data output to provide information to an operator regarding the object 12 such as position and/or movement information.

Three processing methodologies are described herein to process the raw imagery data and produce a low data output at the computer/comparator 20, as described above. In summary, the three processing methodologies are 1) an on-demand detail processing methodology, 2) a three-dimensional (3D) modeling processing methodology, and 3) an image alignment and differencing processing methodology. As described herein, each processing methodology can be used alone or in combination with one of the other processing methodologies. For example, the on-demand detail processing methodology can be used alone or in conjunction with the 3D modeling processing methodology, etc.

Continuing with FIG. 1, an on-demand detail processing methodology can allow an operator at a ground-based operator station 18 to access portions of the raw imagery data. Specifically, raw surveillance imagery is processed by the computer/comparator 20 on the surveillance platform 16 to provide an operator at a ground-based operator station 18 with on-demand detail via adaptive resolution, depending on zoom level. Each region (regardless of zoom level) can be requested by the operator for any point in time. During a surveillance mission, if an operator at a ground-based operator station 18 spots something interesting (i.e. in a low data view), the operator can zoom in and rewind the footage. For the on-demand detail processing methodology, all of the raw data captured by the sensor(s) 22 is not sent to the ground-based operator station 18. Instead, only those portions of the imagery that are of interest to the operator are streamed off the surveillance vehicle to the ground-based operator station 18 in real-time.

For imagery received in real-time, the operator at the ground-based operator station 18 may request a snapshot-on-demand which is a higher-detail image over the current field of view, or a wider geographic area surrounding the current field of view. The live imagery could then be accurately geo-positioned on top of the wider-area snapshot to provide an operator with additional situational awareness to extract more information from the captured data set. Data that has been transferred to a ground-based operator station 18 can be stored in a local cache accessible to multiple operators. With this arrangement, multiple operators that request the similar tiles (i.e. views) do not cause the same data to be transferred twice.

The 3D modeling processing methodology can best be understood with initial cross reference to FIGS. 1 and 2. For this processing methodology, one or more views of a predetermined geographical area (comprising geographical data) are obtained and collectively collated to construct a three-dimensional model 34 of the predetermined area. For example, the sensor(s) 22 can be used to obtain the views and the computer/comparator 20 can be collectively collated to construct a three-dimensional model 34. The views for constructing the three-dimensional model 34 can be obtained, for example, by having an aircraft circle over (i.e. orbit) the area to obtain many different views of the area from many different perspectives. In some cases, the three-dimensional reference model 34 of the predetermined area is constructed on a per-orbit basis. For use in the system 10, the three-dimensional reference model 34 can be periodically updated. With careful flight planning for imaging constraints, a wide-area image sequence of the ground 14 can be captured in such a way as to optimize the 3D reconstruction of that scene with quantified geo-spatial accuracies. The three-dimensional reference model 34 can be created using vision science techniques, known in the pertinent art. In some cases, the three-dimensional reference model 34 is constructed by deriving a camera model with improved position and pose for each camera/sensor 22 (or collection of cameras/sensors 22) in time based on the constraints observed in pixel space. The captured views can be combined with accurate platform information (time, position, and attitude, all with known uncertainties). A new 3D model with texture can be created for each orbit of the surveillance platform 16.

Alternatively, a terrain data model of the predetermined area can be obtained to construct the three-dimensional reference model. For example, the terrain data model may be based on a technique such as Light Detection and Ranging (LIDAR), Digital Terrain Elevation Data (DTED), or a combination of techniques may be used. Calibrated reference imagery can be used to improve the geo-spatial accuracy of the 3D model 34 making it a fantastic reference data set for derivative or processed data products. This process of creating a 3D model on a per-orbit basis is effectively analogous to creating an “I” or reference image for use in video compression, but for 3D data sets instead.

Regardless of where the three-dimensional model 34 is constructed, for the 3D modeling processing methodology, one copy of the 3D model 34 is maintained at the surveillance platform 16, and a copy of the 3D model 34 is maintained at the ground-based operator station 18. Typically, the three-dimensional model 34 is constructed at the surveillance platform 16 and a copy is transmitted to the ground-based operator station 18. Thereafter, the three-dimensional model 34 can be periodically updated at both locations, if needed.

With a copy of the three-dimensional model 34 at the surveillance platform 16 and a copy at the ground-based operator station 18, a surveillance mission can be conducted to identify interesting activity (i.e. movement of objects 12) occurring in the predetermined geographical area. During the surveillance mission, the sensor 22 is used to collect raw imagery data of the activity. The raw data is then processed by the computer/comparator 20 to produce a low data output and the low data output is then transmitted to the ground-based operator station 18. Specifically, the image(s) obtained by the sensor 22 are two-dimensional, and, typically, are made with the lowest effective optical resolution. Further, in some cases, the image can result from an on-demand event (as described above), allowing it to be selectively created from different zoom levels. When tracking a moving object 12 in the geographical area is desired, a succession of these two-dimensional images can be created.

As indicated above, the reference 3D model 34 can be used for other derivative intelligence products at a reduced data-rate. For instance, with a copy of the three-dimensional model 34 at the surveillance platform 16 and a copy at the ground-based operator station 18, differences detected at the surveillance platform 16 between past and present 3D models 34 can be intelligently sent to the ground-based operator station 18. Transmitting the differences between past and present 3D models 34 provides a means of data reduction and limits the transfer bandwidth required to represent those changes at the ground-based operator station 18.

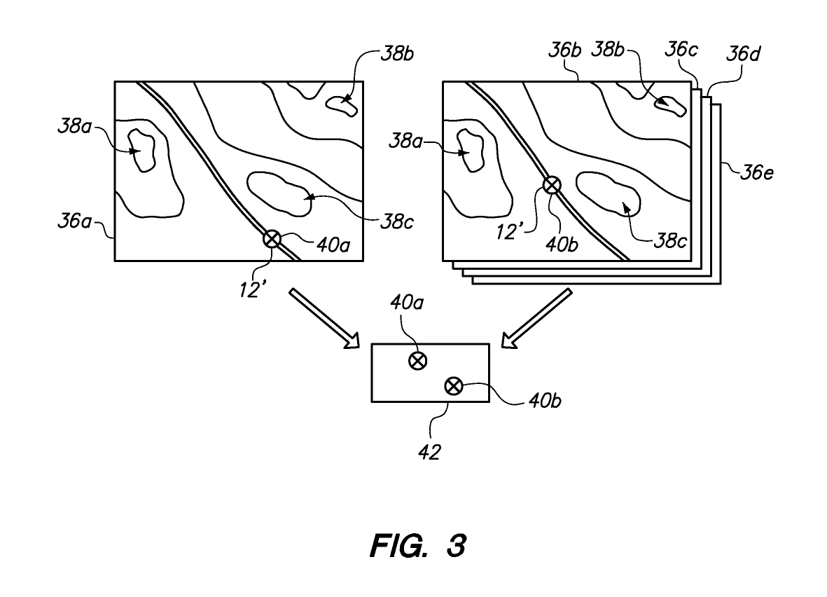

As another example, new 2D imagery captured at the surveillance platform 16 can be properly geo-registered and draped over the 3D reference model 34 and ortho-rectified for use in subsequent derived video regions. Cross referencing FIGS. 2 and 3, it can be seen that each two-dimensional image 36a-e can be aligned with the three-dimensional model 34 at the surveillance platform 16 in a process generally referred to as geo-registration. For example, reference marks 38a-c can be identified in each image 36a-e and used with corresponding reference marks 38a′-c′ in the 3D reference model 34 to geo-register each image 36a-e with the 3D reference model 34. In particular, this geo-registration (alignment) is done to minimize the adverse effects that might otherwise occur with excessive platform motion and/or scene/view angle changes between successive images 36a-e.

Because the 2D image is captured from one angle versus all angles as obtained in the 3D-reconstructed reference model 34, the new draped and ortho-rectified 2D image may not have pixels corresponding to geographic coordinates for the entire field of view of the captured image 36a-e. This could be caused by mountainous terrain, or occlusions behind trees or buildings. In this case, textures from the underlying 3D model 34 can be used to fill in geographic areas not imaged by the sensor 22 as a way to re-use existing data at the ground-based operator station 18 versus having to transmit all raw imagery data captured.

With a 3D model 34 defined in a real-world coordinate space, additional constraints can be placed on objects 12 moving within the scene, which enforce physical motion models of these objects 12. These limits further bound where an object 12 can move within the scene, and provide an improved model for tracking those objects 12 in a geo-spatial coordinates frame instead of pixel space. These derived tracks are then available to be streamed to operators at a ground-based operator station 18 alongside the video, or by themselves. By just sending tracks within an area of interest, the bandwidth requirements are significantly reduced but still provide significant situational awareness that can drive additional exploitation and analysis.

In addition, 2D surveillance imagery can be transformed into a 3D extrusion model that is sent to the operators at a ground-based operator station 18 with a single high-resolution (progressively transferred) 2D overlay image. The overlay could then be updated selectively where motion is detected per the 3D model. By comparing successive high-resolution wireframe models over time, the 3D reference model 34 can be used to detect changes in the model's surface that are consistent with the movement of objects 12. The moving objects 12 (as well as the terrain they were previously occupying) can then be modeled with an increasing degree of accuracy. Shadow modeling (based on time of day/year) may also be used to further refine the 3D model. The accurate, real-time position and attitude of the surveillance platform 16 may also be used to further increase the accuracy of 3D models.

Once the 3D modeling software on the surveillance platform 16 has identified interesting (i.e. moving) objects 12, software instructions can then be executed to send to the ground-based operator station 18 high-resolution (progressive) wireframe data along with high-resolution (progressive) 2D imagery (possibly for overlay onto the wireframe) for just those objects 12 while sending only low-resolution wireframe/imagery of the surroundings for context. An additional benefit of detecting and modeling moving objects 12 on the surveillance platform 16 is the ability to highlight those objects 12 in the transferred imagery regardless of the amount of detail that is currently being sent to the operators at the ground-based operator station 18. Depending on the accuracy of the moving object models, it may also be possible to automatically classify those objects by type (i.e. cars, trucks, tanks, etc.).

FIG. 3 illustrates an image alignment and differencing processing methodology. As shown, a sequence of images 36a-e can be geo-registered and then compared to reveal differences in the images 36a-e that are indicative of activity of an object 12′ (i.e. movements in the geographical area). For example, it can be seen that object 12′ has moved from position 40a in image 36a to position 40b in image 36b. The geo-registration and comparison processing can be performed by the computer/comparator 20 on the surveillance platform 16 shown in FIG. 1. The sequence of images 36a-e can be geo-registered relative to a 3D reference model, such as the 3D reference model 34 shown in FIG. 2 and described above, or, for example, each successive image 36a-e can be geo-registered relative to a previously obtained image 36a-e. FIG. 3 illustrates that the result of the geo-registration and comparison processing is the generation of tracking data 42 which is based on the detected differences between successive images 36a and 36b. This tracking data 42, which includes significantly less data than the acquired raw imagery data, is then transmitted to a ground-based operator station 18. There, at the ground-based operator station 18, the tracking data 42 can be evaluated using, for example, a previously transmitted three-dimensional model 34, or a previously transmitted 2D raw image, to detect movements of object 12′.

The differencing methodology use can be similar to methodologies employed in video codecs. Specifically, key image frames which contain an entire image 36a-e can be transmitted to the ground-based operator station 18 at regular intervals and otherwise only the difference (e.g. tracking data 42) between the current image 36a-e and the previous key frame image 36a-e is sent. The underlying assumption is that not much changes from one image 36a-e to another. Because of that, differencing images 36a-e can usually be compressed very effectively, especially when employing lossy compression algorithms. The effectiveness of this approach can be undermined by excessive motion and/or scene/view angle changes between image frames. However, image stabilization, rectification, and alignment (i.e. geo-registration), as well as contrast normalization, can be used to offset the effects of excessive motion and/or scene/view angle changes between image frames. Accurately geo-registered, the images 36a-e on the surveillance platform 16 can increase the effectiveness of the image alignment and differencing techniques on data reduction. Aside from optimizing the compressibility of differencing image frames, this process of normalizing all image frames to a common orientation and contrast can also be used for 2D motion detection, i.e. differencing ortho-rectified images could be used to highlight changes between frames instead of just displaying those changes.

While the particular systems and methods for wide area motion imagery as herein shown and disclosed in detail are fully capable of obtaining the objects and providing the advantages herein before stated, it is to be understood that they are merely illustrative of the presently preferred embodiments of the invention and that no limitations are intended to the details of construction or design herein shown other than as described in the appended claims.

What is claimed is:

1. A system for detecting a moving object in a predetermined geographical area, using reduced data rate transmissions, which comprises:
a surveillance platform;
a first computer mounted on the surveillance platform, with geographical data on the computer for constructing a three-dimensional reference model of the predetermined area;
an operator station having a second computer with the same geographical data for constructing a three-dimensional reference model of the predetermined area;
a sensor mounted on the surveillance platform for creating a first two-dimensional image of a region of the predetermined area, wherein the first image is geo-referenced with the reference model at the surveillance platform, and for creating a second two-dimensional image of substantially the same region of the predetermined area, wherein the second image is geo-referenced with the reference model at the surveillance platform;
a comparator mounted on the surveillance platform for collecting track data based on a difference between the first and second images, wherein the track data is indicative of a movement of an object in the predetermined area; and
a transmitter mounted on the surveillance platform for transmitting the track data to the operator station for geo-referencing the track data with the reference model at the operator station to detect the moving object.

2. A system as recited in claim 1 wherein the three-dimensional reference model of the predetermined area is constructed on a per-orbit basis.

3. A system as recited in claim 1 wherein the three-dimensional reference model is periodically updated.

4. A system as recited in claim 1 wherein the three-dimensional reference model is leveraged by a terrain data model of the predetermined area.

5. A system as recited in claim 4 wherein the terrain data model is based on a technique selected from the group consisting of Light Detection and Ranging (LIDAR) and Digital Terrain Elevation Data (DTED).

6. A system as recited in claim 1 wherein the region of the predetermined area is selected via adaptive resolution using spot-on-demand imaging techniques.

7. A system as recited in claim 1 wherein the sensor creates an extended sequence of images, with each image being compared with the next sequential image.

8. A system as recited in claim 1 wherein the sensor is a camera.

9. A system as recited in claim 1 further comprising a plurality of sensors with at least one sensor being operative beyond the visible-light spectrum.

10. A system for detecting a moving object in a predetermined geographical area, using reduced data rate transmissions, which comprises:
a surveillance platform;
a first computer means on the surveillance platform, with geographical data on the computer for constructing a three-dimensional reference model of the predetermined area;
an operator station having a second computer means with the same geographical data for constructing a three-dimensional reference model of the predetermined area;
a sensor means for creating a first two-dimensional image of a region of the predetermined area, wherein the first image is geo-referenced with the reference model at the surveillance platform, and for creating a second two-dimensional image of substantially the same region of the predetermined area, wherein the second image is geo-referenced with the reference model at the surveillance platform;
a comparator means on the surveillance platform for collecting track data based on a difference between the first and second images, wherein the track data is indicative of a movement of an object in the predetermined area; and
a transmitting means for transmitting the track data from the surveillance platform to the operator station for geo-referencing the track data with the reference model at the operator station to detect the moving object.

11. A system as recited in claim 10 wherein the three-dimensional reference model of the predetermined area is constructed on a per-orbit basis.

12. A system as recited in claim 10 wherein the three-dimensional reference model is periodically updated.

13. A system as recited in claim 10 wherein the three-dimensional reference model is leveraged by a terrain data model of the predetermined area and wherein the terrain data model is based on a technique selected from the group consisting of Light Detection and Ranging (LIDAR) and Digital Terrain Elevation Data (DTED).

14. A system as recited in claim 10 wherein the region of the predetermined area is selected via adaptive resolution using spot-on-demand imaging techniques.

15. A system as recited in claim 10 wherein the sensor creates an extended sequence of images, with each image being compared with the next sequential image.

16. A method for detecting a moving object in a predetermined geographical area, using reduced data rate transmissions, the method comprising the steps of:
providing a surveillance platform;
constructing a first three-dimensional reference model of the predetermined area on the surveillance platform;
transmitting model data from the surveillance platform to an operator station for constructing a second three-dimensional reference model of the predetermined area at the operator station;
creating a first two-dimensional image of a region of the predetermined area and geo-referencing the first image with the first reference model at the surveillance platform;
creating a second two-dimensional image of substantially the same region of the predetermined area and geo-referencing the second image with the first reference model at the surveillance platform;
collecting track data based on a difference between the first and second geo-referenced images, wherein the track data is indicative of a movement of an object in the predetermined area; and
transmitting the track data from the surveillance platform to the operator station for geo-referencing the track data with the second reference model at the operator station to detect the moving object.

17. A method as recited in claim 16 wherein the three-dimensional reference model of the predetermined area is constructed on a per-orbit basis.

18. A method as recited in claim 16 wherein the three-dimensional reference model is periodically updated.

19. A method as recited in claim 16 wherein the three-dimensional reference model is leveraged by a terrain data model of the predetermined area and wherein the terrain data model is based on a technique selected from the group consisting of Light Detection and Ranging (LIDAR) and Digital Terrain Elevation Data (DTED).

20. A method as recited in claim 16 wherein the region of the predetermined area is selected via adaptive resolution using spot-on-demand imaging techniques.
